(19) United States
(12) Patent Application Publication
(10) Pub. No.: US 2005/0087360 A1
(43) Pub. Date: Apr. 28, 2005

(54) Cable having a filler

(76) Inventor: Richard Walter Speer, Kernersville, NC (US)

Correspondence Address: Tyco Electronics Corporation, Suite 140, 4550 New Linden Hill Road, Wilmington, DE, 19808-2952, US

(21) Appl. No.: 10/693,118

(22) Filed: Oct. 24, 2003

(51) Int. Cl. H01B 11/00

(52) U.S. Cl. 174/113 C

(57) ABSTRACT

A filler and an electrical cable including the filler wherein the filler is positioned within an outer jacket of the cable along with a plurality of conductors. The filler features a core being formed of a foamed material and having a dielectric enhancing section extending there through. The core also includes a plurality of voids that are formed for example, either by using a foaming agent or by the injection of a gas during an extrusion process.

### FIELD OF THE INVENTION

The invention is related generally to cables and more specifically to a cable having a filler between conductors within the cable.

### BACKGROUND OF THE INVENTION

Communications, control and other systems utilizing unshielded or shielded twisted pair cabling continue to require higher data transmission rates. For example, Category 5 UTP cable designed according to Telecommunications Industry Association Standard TIA/EIA 568A meets some of today's demands for some communications networks, however it may not be capable of handling increased data transmission rates and bandwidth requirements of some other networks, since LAN and WAN data transmission rate and bandwidth requirements are ever increasing. The increased data transmission rates come with the need for better signal isolation, electromagnetic interference control, and improved attenuation characteristics. For example, Category 5 UTP cable is specified for frequencies up to 100 MHz and gives a maximum attenuation of 22 dB per 100 meters of cable at 100 MHz. Category 6 cable is specified for higher frequencies and higher bandwidth communication with reduced attenuation over a length of cable.

State of the art cable utilizes varieties of fillers located within the cable for creating more consistent and greater separation between adjacent twisted pairs in order to achieve the higher frequency and higher bandwidth communications over a length of cable. A problem exists, however, in that the fillers that are predominantly used in high speed cables tend to be stiff and therefore adversely affect the bend radius of a cable. These fillers also have a large cross-section thereby undesirably increasing the outer diameter of the cable. Fillers are generally formed of a solid insulative material which has good dielectric properties for providing improved electrical performance. What is needed is a filler that is more flexible to optimize bending, provides improved electrical performance for carrying higher data transmission rate signals while also minimizing the exterior diameter of the cable.

### SUMMARY OF THE INVENTION

The invention is a filler and an electrical cable including the filler. The filler is positioned within an outer jacket of the cable along with a plurality of conductors. The filler features a core being formed of a foamed material and having a dielectric enhancing section extending therethrough. The core also includes a plurality of voids that are formed for example, either by using a foaming agent or by the injection of a gas during an extrusion process.

### BRIEF DESCRIPTION OF THE DRAWINGS

The invention will now be described by way of example with reference to the accompanying figures of which:

FIG. 1 is a cross sectional view of a cable according to the invention;

FIG. 2 is a cross sectional view of a core for use in the cable of FIG. 1;

FIG. 3 is a cross sectional view of first alternate core according to the invention; and

FIG. 4 is a second alternate core according to the invention.

### DETAILED DESCRIPTION OF THE PREFERRED EMBODIMENTS

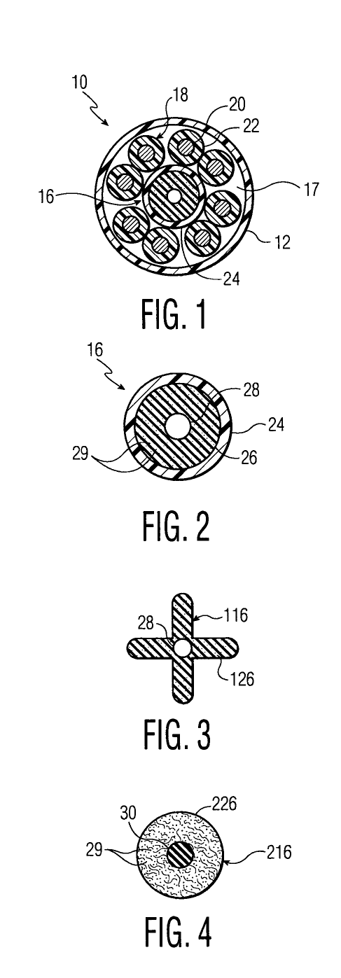

A cable 10 according to the invention will now be described in greater detail with reference to FIG. 1. An outer jacket 12 encloses the cable 10 and extends along the length thereof along with the other able elements that will be described below. The outer jacket 12 is formed of a suitable insulative material. The outer jacket 12 may be selected from suitable insulative materials for a particular cable application or from a group of well known insulative low smoke, low toxicity materials for use in plenum applications. Suitable insulative materials include but are not limited to PVC, FRPVC, FEP, FEP Alloy, LSZH (Low Smoke Zero Halogen), and other fluoropolymers such as Halar or MFA. Inside the outer jacket 12 is a wire receiving section 17. Wires 18 are located within the wire receiving section 17. Each wire 18 is of conventional construction and includes a conductor 20 surrounded by insulation 22. The wires 18 may be optionally disposed in twisted pairs as is well known in the communications wiring industry. A filler 16 is provided within the wire receiving section 17.

Turning now to FIG. 2, the filler 16 will be described in greater detail. The filler 16 consists of a core 26 having a dielectric enhancing section 28 therein. An outer skin 24 surrounds the core 26. The dielectric enhancing section 28 in this embodiment is a centrally located hollow tubular structure that lowers the dielectric constant of the core 26 as it may advantageously contain air. The core 26 is preferably formed of an insulative material which is extruded using a foaming agent to create a plurality of voids 29. The voids 29 within the core 26, which could contain air or other gases, will result in a lower dielectric constant giving more favorable electrical performance. Therefore, it is preferred to maximize the amount of foaming and number of voids 29 to the extent allowable by restrictions placed on the filler 16 by mechanical requirements, such as bend radius and the internal forces necessary to maintain the wires 18 in a proper orientation. Alternatively, the core 26 could be formed by injecting air or another gas into the insulative material during extrusion. Suitable materials for the core 26 include but are not limited to floropolymers, polyethylene or polypropylene. The relatively thin outer skin 24 may be applied through a second extrusion by coating over the core 26. Alternatively, the outer skin 24 could be co-extruded with the core 26. The outer skin 24 may be formed of similar insulative materials as the core 26 but without the foaming agent.

The filler 16 may be formed in a variety of shapes as required by a particular cable construction. For example, a first alternate embodiment of the present invention is shown in FIG. 3 in which a filler 116 is formed in an alternate cross shape. It should be understood that while the cross shape is shown here to have two perpendicular legs intersecting at a center, other cross shaped arrangements having different numbers of legs which are oriented at different angles to each other are within the scope of the invention. The filler 116 also features a core 126 which is formed of a similar foamed material. The core 126 surrounds a similar dielectric enhancing section 28 located approximately at the center thereof. The outer skin 24 is not included in this embodiment and may be optionally applied similar to the embodiment of FIG. 2. This cross shaped filler 116 advantageously maintains the wires 18 in a specified orientation along the length of the cable 10 for improved signal-to-signal isolation and increased data transmission rates.

A second alternate embodiment of the present invention is shown in FIG. 4 in which a filler 216 consists of a core 226 having a dielectric enhancing section formed of a thread 30. In this embodiment, the thread 30 is fiberglass which is co-extruded with the core 226 formed of foamed neoprene rubber. Foaming creates, voids 29 similar to the embodiments described above and advantageously lowers the dielectric constant of the core 216. Neoprene is preferable because it is more flexible than polyethylene or polypropylene; however, neoprene does not provide the added mechanical strength of polyethylene or polypropylene. The thread 30 therefore can serve to supplement the mechanical strength of the material used in filler 216.

The cable having a filler as described in these embodiments has advantageous properties of a lower dielectric constant and therefore greater signal-to-signal isolation for achieving higher data transmission rates through the cable. Since each of the fillers have a dielectric enhancing section located within its core, the dielectric constant of the filler is lowered. Additionally, the dielectric constant is lowered through the introduction of a foaming agent or other gas to create voids within the filler. Foaming also advantageously contributes to greater cable flexibility while minimizing the cables outer diameter.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. (canceled)

2. (canceled)

3. An electrical cable comprising:
an outer jacket;
a plurality of conductors within the outer jacket; and,
a filler having a core within the outer jacket, the core having a dielectric enhancing section extending therethrough and a plurality of voids substantially surrounding the dielectric enhancing section by the dielectric enhancing section is formed as a hollow tubular structure, and,
an outer skin surrounding the core.

4. The electrical cable of claim 3 wherein the core is extruded with a foaming agent to create the voids.

5. The electrical cable of claim 4 wherein the core is selected from the group of materials consisting of polyethylene, polypropylene, floropolymers, and neoprene.

6. The electrical cable of claim 3 wherein the dielectric enhancing section is formed of a thread.

7. The electrical cable of claim 3 wherein the dielectric enhancing section is formed as a hollow structure.

8. The electrical cable of claim 7 wherein the core is cross shaped in cross section.

9. A filler for use in an electrical cable comprising:
a core formed of a foamed material substantially surrounding a dielectric enhancing section; and,
an outer skin formed of an insulative material surrounding the core.

10. The filler of claim 9 wherein the dielectric enhancing section is formed as a hollow structure.

11. The filler of claim 9 wherein the foamed material is selected from the group of polyethylene, polypropylene, floropolymers, and neoprene.

12. The filler of claim 10 wherein the core is formed in the shape of a cross.

13. The filler of claim 9 wherein the dielectric enhancing section is formed of a thread.
